(19) United States
(12) Patent Application Publication
(10) Pub. No.: US 2026/0091363 A1
(43) Pub. Date: Apr. 2, 2026

(54) CONTAINERS WITH INTERNAL AGITATORS

(71) Applicant: BLENDBOX LLC, Hohokus, NJ (US)

(72) Inventor: Adam SASSO, Hohokus, NJ (US)

(21) Appl. No.: 18/899,258

(22) Filed: Sep. 27, 2024

(51) Int. Cl. B01F 33/501; B01F 35/53; B31B 50/20; B31B 50/62; B65D 5/40

(52) U.S. Cl. CPC B01F 33/50111; B01F 35/531; B31B 50/20; B31B 50/624; B65D 5/40

(57) ABSTRACT

A container for dissolving powder in liquid for consumption is made from a single piece of coated paper, and has two internal agitators when the paper is folded and glued. Before assembly, the paper is cut in a pattern and laid out with an outer portion and an inner portion defined by a first fold line. The inner portion is folded over and glued to the outer portion, and the outer portion is folded into a rectangular tube. The agitators are formed in the inner portion with creases and cuts so that the agitators unfold into the container when the outer portion is folded. The tube is then sealed at the top and bottom. The agitators have openings so that liquid in the container is mixed when the container is shaken. A removable cap is provided for filling and drinking from the container.

This invention relates to containers for liquids, and more particularly, to containers for liquids that are made from a single piece of coated paper and have two internal agitators.

### BACKGROUND OF THE INVENTION

Hard plastic bottles with screw-on lids and a removable metal whisk are currently available. When a user adds liquid and a powder (protein powder, etc.) into the container and inserts the whisk, the liquid and powder emulsify when the container is shaken, avoiding unpleasant clumps of unmixed powder. However, the primary material is plastic, which has been shown to leach PFAS (better known as “forever chemicals”) into the liquid housed in the container, that can be ingested by a human. Also, because the container is plastic and typically used to mix protein, it harbors bacteria that is difficult to clean completely from the interior surfaces and leads to foul smelling containers, even after washing. Thus, there is a need for mixing containers made of food safe materials that are resistant to bacteria. Additionally, this design is completely recyclable, which many of the plastic alternatives are not (even though they are plastic).

One solution is to provide a baffle in a paper container, as described in U.S. Pat. No. 11,439,964. In that paper container, one baffle extends between the bottom and top of the container. The baffle is not adequately effective, and the container is awkward and costly to manufacture. In addition, the design of the baffle makes it difficult for the box to collapse flat for cost effective transport/shipping. Thus, there is a need for containers for liquids with improved mixing that are less awkward, easier to manufacture and ship, and more effective at emulsifying.

Accordingly, one object of this invention is to provide new and improved containers for liquids.

Another object is to provide new and improved containers for liquids having internal agitators.

Yet another object is to provide new and improved containers having internal agitators that can be mass produced economically.

### SUMMARY OF THE INVENTION

In keeping with one aspect of this invention, a container for liquids such as juice or milk is made from a single piece of coated paper (SBS or Solid Bleached Sulfate and/or FBB (folded box board)) and has two internal agitators or “Kites” when the paper is folded and glued. Before assembly, the paper is cut in a pattern and laid out with an outer portion and an inner portion defined by a first fold. The inner portion is folded over and glued to the outer portion, and the outer portion is folded into a rectangular tube. The agitators are formed in the inner portion with creases so that the agitators unfold into the container when the outer portion is folded. The tube is then sealed at the top and bottom. The agitators or “kites” have openings so that liquid is captured by them and forced through small openings, creating an emulsifying effect when the container is shaken. A top opening with a screw-on cap is integrated into the design for the end user to add their own ingredients as well as drink from the carton/box.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a perspective view of one embodiment of a container made in accordance with the invention;

FIG. 2 is a plan view of a piece of coated paper used to make the container of FIG. 1;

FIG. 3 is a plan view of the paper of FIG. 2 after adhering an inner portion to an outer portion;

FIG. 4 is an elevation view of the paper of FIG. 2, adhered to form a rectangular tube;

FIG. 5 is a partial perspective view of an agitator as it folds inside of the container of FIG. 1;

FIG. 6 is a plan view of the interior of the tube of FIG. 5, showing the two agitators folded into the interior of the tube; and

FIG. 7 is a plan view of an alternate embodiment of the paper of FIG. 2.

### DETAILED DESCRIPTION

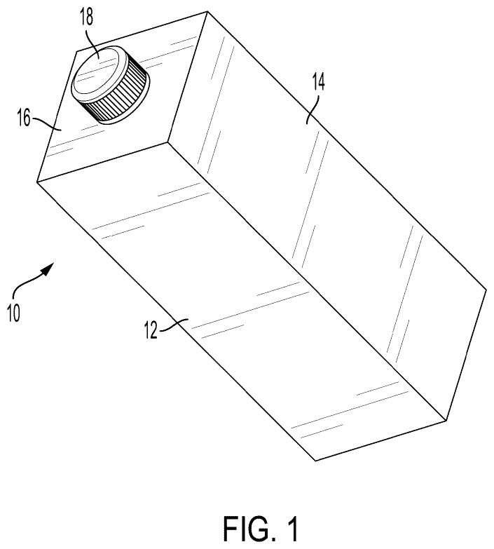

As seen in FIG. 1, a container 10 is generally rectangular, with four walls including a wall 12 and a wall 14, a sealed top 16, and a sealed bottom (not shown). A screw cap 18 is provided. With the screw cap 18 removed, powder can be placed in the container 10, perhaps before sale to a consumer. In that event, the consumer can remove the cap 18, pour liquid into the container 10, and secure the cap 18. When the cap 18 is secured, the container 18 can be shaken to thoroughly dissolve the powder in the liquid.

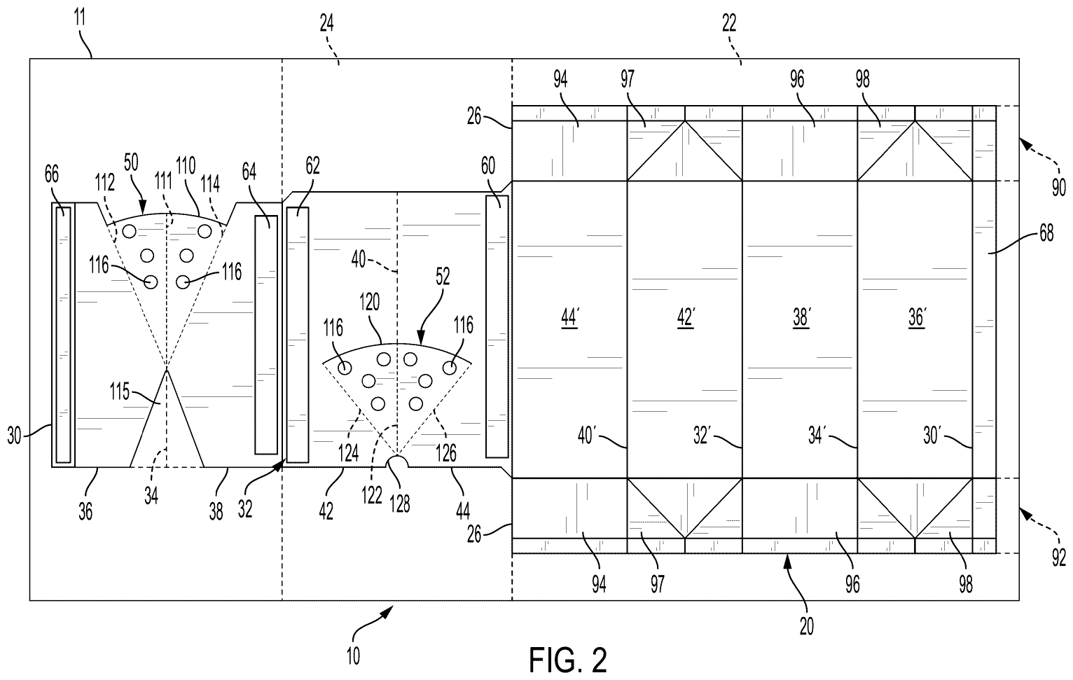

Referring now to FIG. 2, the container 10 is made from a single piece of coated paper 20 cut from paper stock 11. The paper 20 has an outer portion 22 and an inner portion 24 separated by a first fold line 26.

The inner portion 24 has an outer edge 30 and a first inner fold line 32 between the outer edge 30 and the first fold 26, and a second inner fold line 34 between the outer edge 30 and the first inner fold line 32. The outer edge 30 and the first inner fold line 32 define a first inner panel 36, and a second inner panel 38 is defined between the first inner fold line 32 and the second inner fold line 34.

The inner portion 24 also has a third inner fold line 40 between the first inner fold line 32 and the fold line 26. The first inner fold line 32 and the third inner fold line 40 define a third inner panel 42, and the third inner fold line 40 and the first fold line 26 define a fourth inner panel 44.

The inner portion 24 has a first agitator 50 spanning the first and second inner panels 36, 38 across the second inner fold line 34, and a second agitator 52 spanning the third and fourth inner panels 42, 44, across the third inner fold 40.

The inner portion 24 has a first adhesive strip 60 adjacent to the first fold line 26, a second adhesive strip 62 adjacent to one side of the second fold line 32, a third adhesive strip 64 adjacent to an opposite side of the second fold line 32, and fourth adhesive strip 66 adjacent to the outer edge 30. The adhesive strips 60, 62, 64 and 66 secure the inner portion 24 to the outer portion 22 when the inner portion 24 is folded at the first fold 26, in the manner seen in FIG. 3.

The outer portion 22 (FIG. 2) has first, second, third and fourth outer panels 44′, 42′, 38′ and 36′ defined by the first, second, third and fourth inner panels 44, 42, 38 and 36 of the inner portion 24 when the inner portion 24 is adhered to the outer portion 22, and fold lines 40′, 32′, 34′ and 30′ that correspond to the fold lines 40, 32, 34 and 30 respectively.

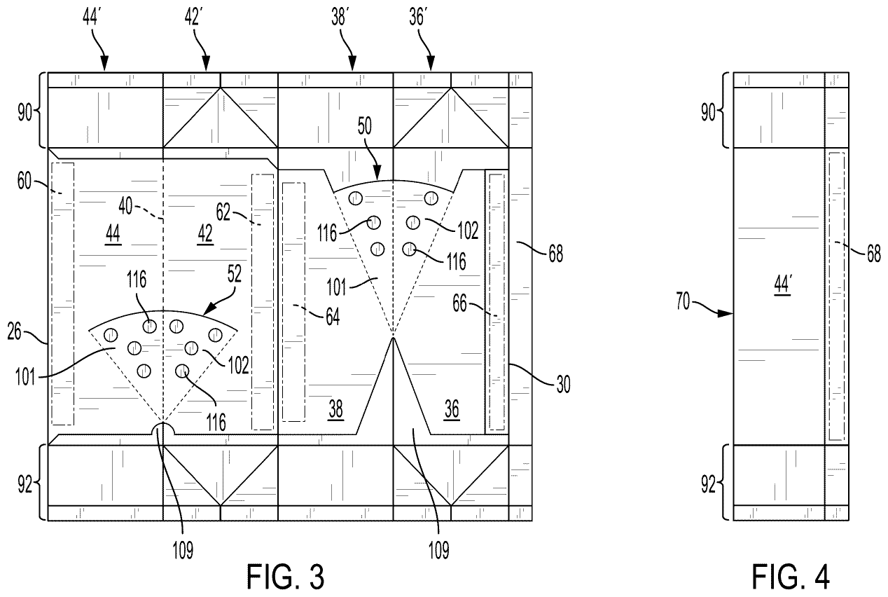

The container is assembled by folding the panels 44′ and 42′ at the fold line 40′, folding the panels 42′ and 38′ at the fold line 32′, and folding the panels 38′ and 36′ at the fold line 34′. The outer portion 22 also has a fifth panel 68 for adhesively sealing the fourth outer panel 36′ to the first outer panel 44′ when the first, second, third and fourth panels 44′, 42′, 38′ and 36′ are folded into a rectangular tube 70, as seen in FIG. 4. At this point, the tube could be flattened, stacked and shipped to a customer for filling and sealing if desired.

The outer portion 22 (FIG. 2) has a top section 90 and a bottom section 92 for sealing the container 10 after the tube 70 is formed. The panels 44′ and 38′ have flat flaps 94, 96, and the panels 42′ and 36′ have creased flaps 97, 98. The top section 90 and bottom section 92 are closed by pressing the creased flaps 97, 98 inwardly, folding the flat flaps 94, 96 over the creased flaps 97, 98, and adhering the outermost flap to the adjacent flap. The cap 18 seen in FIG. 1 can be installed in the top section 90.

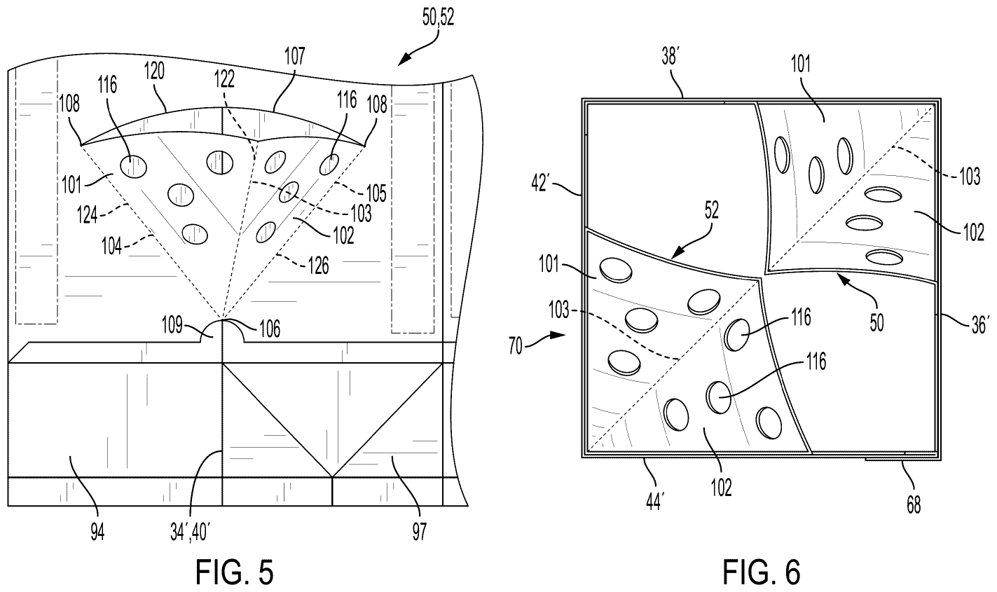

The agitators 50, 52 will now be described in more detail, first with reference to FIG. 5. Both agitators have first and second panels 101, 102 defined by a first crease 103 along a selected inner fold line 34′ or 40′. First and second angular creases 104, 105 intersect the first crease 103 along the selected inner fold line 34′ or 40′ at 106. An arced outer edge 107 spans outer ends 108 of the first and second angular creases 104, 105, and a notch 109 at the intersection 106 of the first and second angular creases 104, 105. A plurality of openings 116 allow liquid to pass through the agitators when the container is shaken, and agitate the liquid as it passes.

The creases 103, 104 and 105 facilitate folding of the panels 101, 102 into the inside of the container when the container is assembled. When the tube 70 is assembled, the agitators 50, 52 fold into the interior of the tube 70, as seen in FIG. 6.

Before assembly of the embodiment shown in FIG. 2, the coated paper is cut so that the agitator 50 has an exposed arced outer edge 110, and is creased at 111 along the inner fold line 34. It also has first and second angular creases 112, 114 that cross each other at the crease 111. A notch 115 is provided to facilitate folding of the agitator 50 into the interior of the container 10 when assembled. A plurality of the openings 116 produce turbulence and agitation when the container 10 contains liquid and is shaken.

Still referring to FIG. 2, the agitator 52 is made by providing a cut edge 120, and is creased at 122 along the inner fold line 40. It also has first and second angular creases 124, 126 that cross each other at the fold line 40. A notch 128 is provided to facilitate folding of the agitator 52 into the interior of the container 10 when assembled. The openings 116 produce turbulence and agitation when the container 10 contains liquid and is shaken.

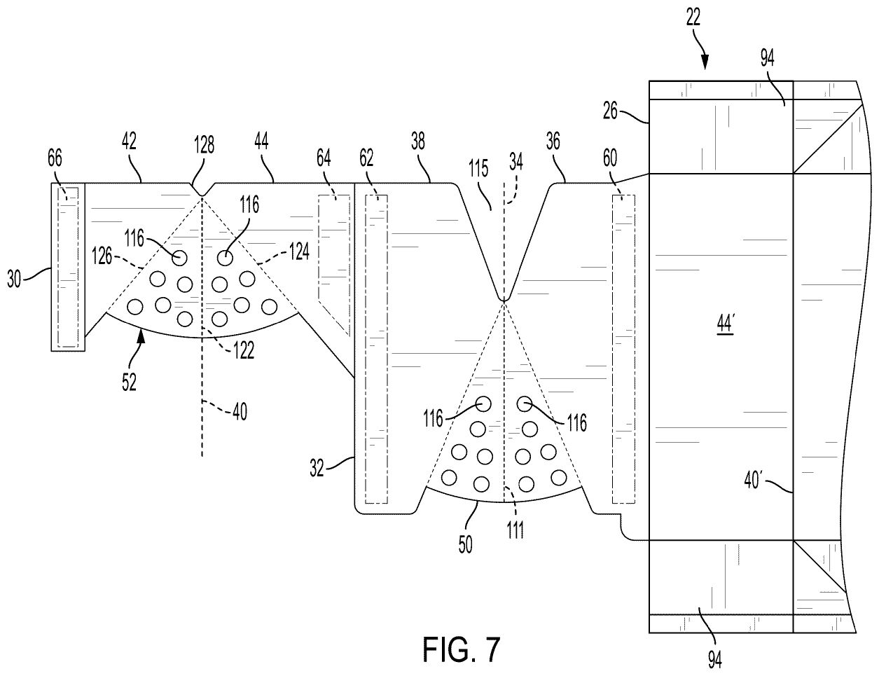

In FIG. 7, the positions of the agitators 50, 52 are essentially reversed so that the agitator 50 is adjacent to the fold line 26, and the agitator 52 is adjacent the outer edge 30. In addition, the slit 120 in FIG. 6 is eliminated in the configuration of FIG. 7 by cutting out an entire portion of the panels 42, 44.

Many advantages are now apparent. The container can be made of food safe, recyclable materials. It is efficient to manufacture and ship, and more effective at emulsifying. It is effective at emulsifying not only protein powders, but also green juice powder, vitamin powder, and also powdered medications for doctors and hospitals.

While the principles of the invention have been described above in connection with specific apparatus and applications, it is to be understood that this description is made only by way of example and not as a limitation on the scope of the invention.

What is claimed is:

1. A container comprising:
a single sheet of a coated paper product having an outer portion and an inner portion defined by a first fold,
the inner portion having an outer edge and a first inner fold between the outer edge and the first fold,
a second inner fold between the outer edge and the first inner fold that defines a first inner panel,
a third inner fold between the first inner fold and the first fold, the first and third inner folds defining a third inner panel, and the third inner fold and the first fold defining a fourth inner panel,
the inner portion further having a first agitator spanning the first and second inner panels across the second inner fold, and a second agitator spanning the third and fourth inner panels across the third inner fold;
the inner portion being adhered to the outer portion by a first strip of adhesive adjacent to the first fold, a second strip of adhesive adjacent to one side of the second fold, a third strip of adhesive adjacent to an opposite side of the second fold, and a fourth strip of adhesive adjacent to the outer edge of the inner portion;
the outer portion having first, second, third and fourth outer panels defined by the first, second, third and fourth inner panels of the inner portion when the inner portion is adhered to the outer portion, the outer portion being folded into a rectangular tube and having a fifth panel for adhesively sealing the tube,
the outer portion further having means for closing a top and a bottom of the rectangular tube to complete assembly of the container,
the container further having means for opening and closing the container,
whereby powder and liquid can be placed in the container, agitated to dissolve the powder, and removed from the container in use.

2. The container of claim 1 wherein
the first and second agitators have first and second panels defined by a first crease along a selected inner fold line,
first and second angular creases that intersect the first crease along the selected inner fold line,
an arced outer edge spanning outer ends of the first and second angular fold lines, and
a notch at the intersection of the first and second angular fold lines.

3. The container of claim 1 wherein the means for closing and sealing the top and bottom of the container includes a first flat panel at an end of the first panel, a first foldable panel at an end of the second panel, a second flat panel at an end of the third panel, and a second foldable panel at an end of the fourth panel.

4. The container of claim 1 wherein the means for opening and closing the container includes a screw cap.

5. A method of manufacturing the container of claim 1 comprising
cutting a single piece of coated paper from paper stock to prepare the inner portion, the outer portion, and the first and second agitators,
applying adhesive to the first, second, third and fourth adhesive strips,
folding the inner portion over the outer portion at the first fold line and adhering the first glue strip to the outer portion adjacent to the fold line, adhering the second glue strip to the outer portion adjacent to the second fold line, adhering the third adhesive glue strip to an opposite side of the second fold line, and adhering the fourth adhesive strip adjacent to the fifth panel of the outer portion,
folding the container at the second, third and fourth fold lines to form a rectangle,
folding and adhering the fifth panel to the fourth panel to form the rectangular tube,
the first and second agitators being folded inwardly inside of the tube as the rectangular tube is formed, and
closing and sealing the top and bottom of the container by folding the first and second foldable panels, folding the first and second flat panels over the first and second foldable panels, and adhering the first or second flat panel to seal the container.
